(19) United States
(12) Patent Application Publication
(10) Pub. No.: US 2025/0187519 A1
(43) Pub. Date: Jun. 12, 2025

(54) CONVERTIBLE CAR SEAT WITH REMOVABLE CUP HOLDER

(71) Applicant: Britax Child Safety, Inc., Fort Mill, SC (US)

(72) Inventor: Mitchell Shellenberger, Mount Joy, PA (US)

(21) Appl. No.: 18/970,233

(22) Filed: Dec. 5, 2024

Related U.S. Application Data
(60) Provisional application No. 63/606,670, filed on Dec. 6, 2023.

(51) Int. Cl. B60N 3/10; B60N 2/28

(52) U.S. Cl. CPC B60N 3/103; B60N 2/2821

(57) ABSTRACT

Systems and methods for a convertible car seat with removable cup holder in accordance with embodiments of the invention are disclosed. In one embodiment, a convertible car seat includes an outer shell having a seat portion and a back portion, and a removable cup holder assembly.

### PRIORITY CLAIM AND CROSS-REFERENCE TO RELATED APPLICATIONS

This application claims priority to and the benefit of U.S. Provisional Patent App. No. 63/606,670 filed Dec. 6, 2023, titled CONVERTIBLE CAR SEAT WITH REMOVABLE CUP HOLDER, the contents of which are incorporated by reference herein in their entirety and relied upon.

### TECHNICAL FIELD

The present invention is generally related to child restraint systems, and more specifically to seats specially adapted for vehicles. More particularly, the present invention relates to a cup holder attachable to a juvenile car seat.

### BACKGROUND

Convertible car seats are designed to protect children in vehicles from the effects of impacts or sudden changes in motion (e.g., sudden acceleration, sudden deceleration, etc.).

### SUMMARY

Systems and methods for a convertible car seat with a removable cup holder in accordance with embodiments of the invention are disclosed. In one embodiment, a convertible car seat includes an outer shell having a seat portion, a back portion, and a receiving port. The convertible car seat also includes a cup holder assembly configured to selectively couple to the receiving port.

Other objects, advantages and novel features, and further scope of applicability of the present invention will be set forth in part in the detailed description to follow, and in part will become apparent to those skilled in the art upon examination of the following, or may be learned by practice of the invention. The objects and advantages of the invention may be realized and attained by means of the instrumentalities and combinations particularly pointed out in the claims.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 is a rendering of a convertible car seat having a removable cup holder in accordance with an embodiment of the invention;

FIG. 2 is a rendering of a convertible car seat having at least one removable cup holder in accordance with an embodiment of the invention;

FIG. 3A-B depicts a removable cup holder assembly in accordance with an embodiment of the invention;

FIG. 4 is a rendering of a removable cup holder assembly in accordance with an embodiment of the invention;

FIGS. 5A-5B depict a receiving port of the convertible car seat in accordance with an embodiment of the invention;

FIG. 5C illustrates an internal cross-sectional view of a receiving port in engagement with an engagement member of a removable cup holder assembly in accordance with an embodiment of the invention; and

FIG. 6 depicts a removable cup holder being coupled to a car seat in accordance with an embodiment of the invention.

### DETAILED DESCRIPTION

Turning now to the drawings, systems and methods for a convertible car seat with a removable cup holder in accordance with embodiments of the inventions are disclosed. A convertible car seat is a car seat that is used for children. Generally, there are two modes of convertible car seats, rear-facing and forward facing. Rear-facing convertible car seats can be used for newborn and toddlers. Forward-facing convertible car seats can be used for children that fit the height and weight requirements. While it is important for a car seat to be properly secured to a vehicle (e.g., car seat or underlying structure) to protect the child, it is also important that the car seat be properly sized and configured to support the child correctly and provide maximum protection in the event of an impact. Car seats may include attachments that may be used while the car seat is installed in a vehicle or when the seat is used as a stand-alone carrier. Similarly, it is important that attachments to the car seat are secure in the event of an impact.

Convertible car seats in accordance with embodiments of the invention include a removable cup holder assembly. The removable cup holder allows a user to insert a cup holder to the convertible car seat to hold items such as a cup, bottle, toy, pacifier, etc. By allowing a user to attach additional structures to the car seat and adapt the utility of the seat, a convertible car seat provides added utility for the user (especially when used as a carrier). Systems and methods for convertible car seats with removable cup holders in accordance with embodiments of the invention are described in more detail below.

The convertible car seat may be similar in most of its construction to a seat disclosed in US 2023/0256874 to the Applicant. In view of this, a number of components of the convertible car seat 100, which are described in US 2023/0256874 may not described herein in detail. Instead, reference is made to the corresponding description and drawings of US 2023/0256874, which are incorporated herein by reference in their entirety.

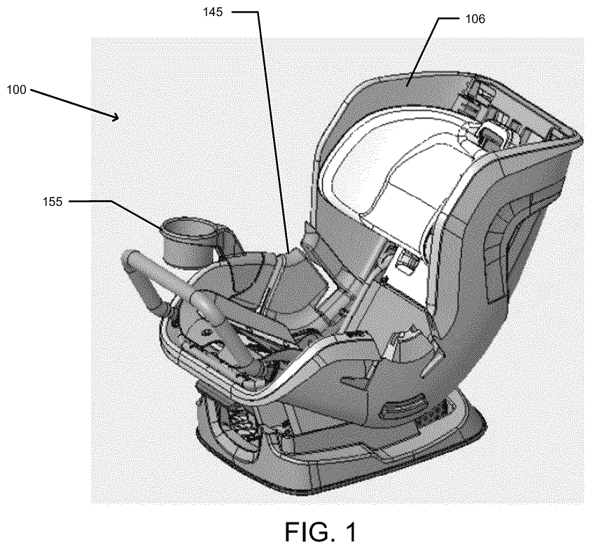

Generally, the convertible car seat 100, similar to that described in US 2023/0256874, may include an outer shell 106 and a base assembly. In an example, the base assembly includes belt paths and/or a variety of mechanisms, such as a click-tight belt retainer, for mounting the convertible car seat 100 on a vehicle seat in a vehicle. The outer shell 106 may have a seating portion and a back portion. In an example, the seating portion includes a seat holding the child's legs and the back portion includes a seat back holding the child's upper body. The back portion may further include a headrest (e.g., adjustable headrest) supporting the child's head (see FIG. 1A of US 2023/0256874).

### Convertible Car Seat

FIG. 1 is a rendering of a convertible car seat having a cup holder attachment assembly in accordance with an embodiment of the invention. The convertible car seat 100 includes an armrest portion 145 and a removable cup holder assembly 155. As noted above, the convertible car seat 100 may be similar to and include one or more features described in US 2023/0256874, such as an outer shell and a base assembly (e.g., outer shell 106 and base assembly 114). Similarly, convertible car seat 200 may include an outer shell and a base assembly (e.g., outer shell 206 and base assembly 214 as described in US 2023/0256874).

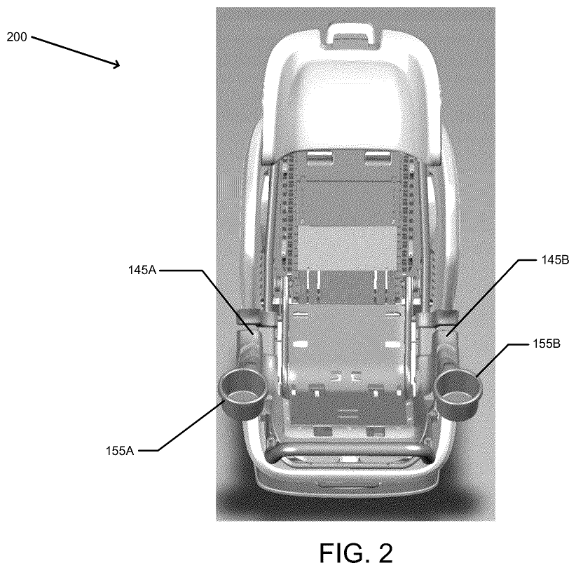

As shown in FIG. 2, the convertible car seat 100, 200 may include more than one cup holder assembly 155 (e.g., cup holder assembly 155A-B). For example, convertible car seat 200 may include cup holder assembly 155A and cup holder assembly 155B. In an example cup holder assembly 155A may selectively couple to a right-hand- side of the convertible car seat 200 and cup holder assembly 155B may selectively couple to a left-hand-side of the convertible car seat 200. More specifically, cup holder assembly 155A may selectively couple to a right armrest portion 145A of convertible car seat 200. Similarly, cup holder assembly 155B may selectively couple to a left armrest portion 145B of convertible car seat 200.

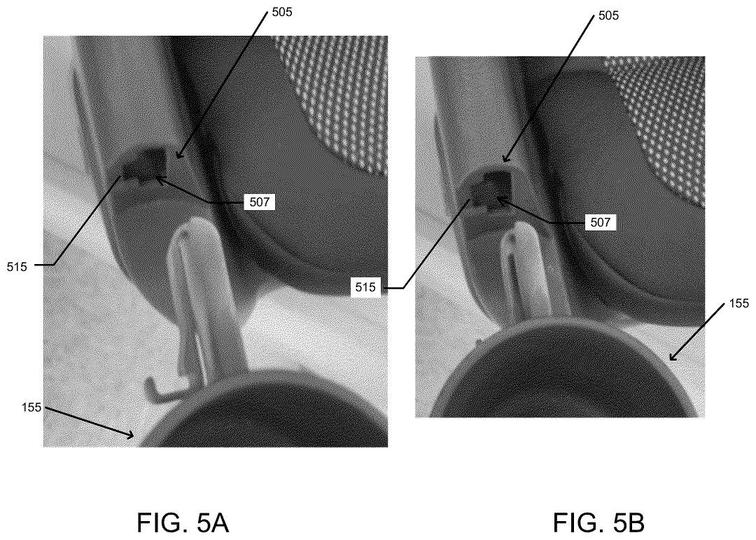

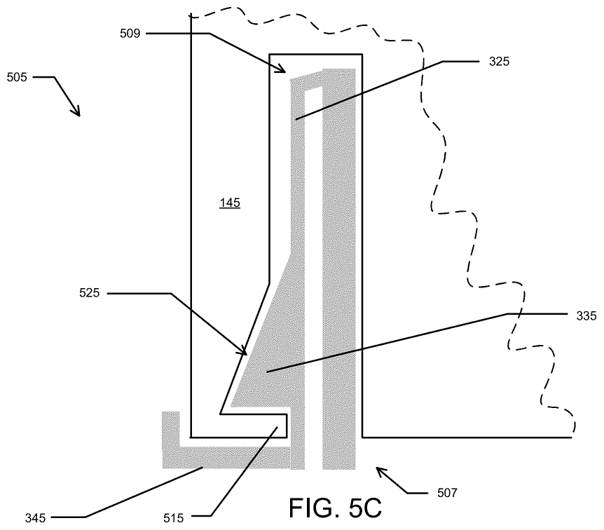

Cup holder assembly 155 is configured to be selectively coupled to convertible car seat 100, 200. Once selectively coupled, the cup holder assembly 155 remains fixed to the seat 100, 200 until selectively decoupled. As noted above, cup holder assembly 155A may selectively couple to the right-hand-side of the convertible car seat 100, 200 while cup holder assembly 155B selectively couples to the left-hand-side of convertible car seat 100, 200. Additional examples of cup holder assembly 155 selectively coupling to convertible car seat 100, 200 is illustrated in FIGS. 5A-5C, which is described in more detail below.

In an example, the armrest portion 145 may be formed by outer shell 106 such that the outer shell has a seating portion, a back portion and an armrest portion 145. It should be appreciated that the cup holder assembly 155 may attach to other portions of the convertible car seat 100, 200. For example, convertible car seat 100, 200 may include cup holder mating and support structures other than armrest portion(s) 145. In an example, armrest portion(s) 145 may include additional cup holder mating and support structures. One example mating and support structure is illustrated in FIGS. 5A-5C, which is described in more detail below.

Although a variety of convertible car seats in accordance with embodiments of the invention are shown with respect to FIG. 1 and FIG. 2, any of a variety of convertible car seats, including those that have fewer or more components, can be utilized as appropriate to the requirements of specific applications of embodiments of the invention.

### Modular Cupholder

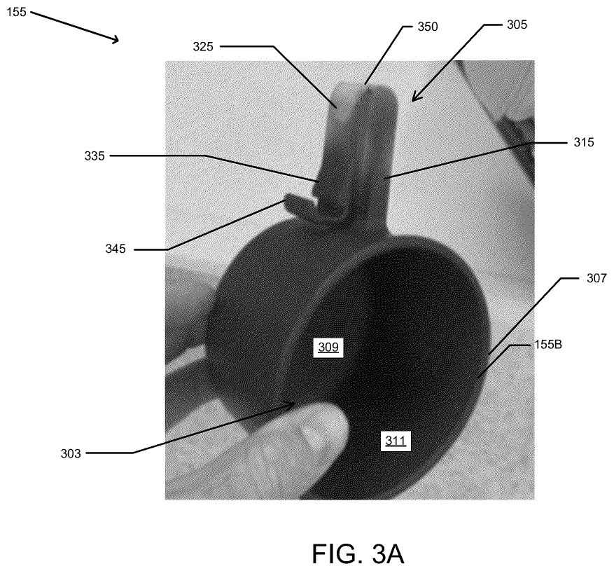

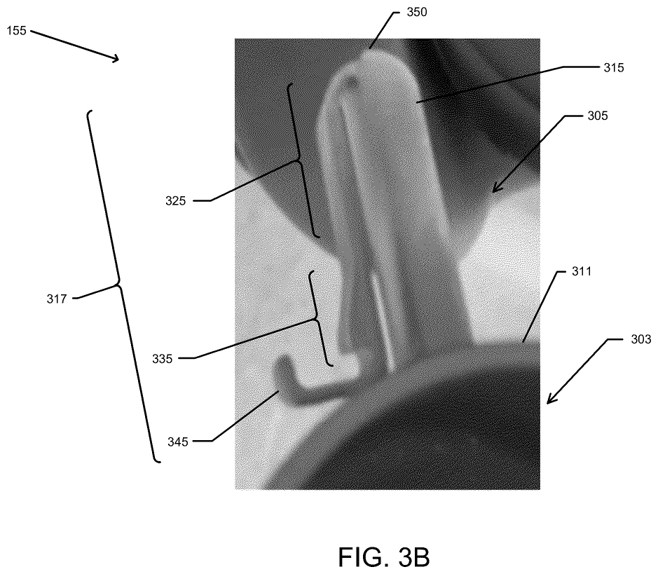

Referring now to FIGS. 3A and 3B, cup holder assembly 155 includes a receptacle 303 and an engagement member 305. The receptacle 303 includes a top 307, a bottom 309, and side walls 311. In the illustrated example, receptacle 303 has cylindrical side walls 311 extending from a closed bottom 309 to an open top 307. It should be appreciated that the cup holder assembly 155 may be sized and shaped to hold several different items, such as a cup, bottle, toys, pacifier, etc. In some examples, the receptacle 303 may have straight side walls 311 forming a rectangular or triangular storage space. In other examples, the side walls 311 and/or bottom 309 may be made from a flexible material that allows for the storage space created by the receptacle 303 to flex and expand around objections placed within the receptacle's storage space.

In other examples, receptacle 303 may have a corresponding cap, lid or closure system. Additionally, the cap, lid or closure system may include a lock or closing tab to secure the cap or lid on the receptacle 303.

As illustrated in FIG. 5A and shown in more detail in FIG. 5B, cup holder assembly 155 includes an engagement member 305 configured to engage with a receiving port (see FIGS. 5A and 5B). The engagement member 305 is sized and shaped such that the engagement member 305 can be inserted in, retained within, and released from the corresponding receiving port on seat 100, 200. In an example, engagement member 305 may include an insertion peg 315, a flex portion 325, a tab portion 335, and a releasing portion 345. In one example, flex portion 325, tab portion 335 and releasing portion 345 may all reside along the same engagement arm 317. In the illustrated example, flex portion 325 and insertion peg 305 are joined at the distal end 350 of engagement member 305.

The flex portion 325 is configured to flex from an “initial” position (illustrated in FIGS. 3A-3B) to an “insertion” position (not illustrated) such that tab portion 335 is sufficiently flexed towards the insertion peg 315 to allow the receiving port to completely receive engagement member 305. For example, when completely received, the insertion peg 315, flex portion 325 and tab portion 335 are entirely housed within the receiving port.

In one embodiment, tab portion 335 may be ramp-shaped or may include a ramp structure configured to engage corresponding structure of the receiving port. In an example, the distal end 350 of the engagement member 305 of the cup holder assembly 155 is configured to be inserted into the receiving port until tab portion 335 interacts with corresponding structure of the receiving port (e.g., a ramp press 515). Upon applying additional force and continuing to insert the cup holder assembly 155, the ramp press 515 (or other suitable structure) of the receiving port engages tab portion 335 as the ramp-shaped tab is pushed along the ramp press. As the receiving port and tab portion 335 engage with each other, the flex portion 325 is configured to flex from the “initial” position towards the “insertion” position. The rigid structure (e.g., ramp press 515) of the receiving port continues to contact the ramp-shaped tab portion 335 until the flex portion 325 fully flexes to the “insertion” position and the cup holder assembly 155 can be fully inserted. Once the tab portion 335 extends beyond the ramp press, the flex portion 325 is configured to flex back to the “initial” position now that the tab portion 335 and ramp press 515 are no longer in contact and applying forces to each other. After the flex portion 325 flexes back to the “initial” position, the ramp press serves as a locking mechanism until the releasing portion 345 is actuated by a user.

Releasing portion 345 is sized and shaped to allow a user to interact with the releasing portion 345 once the cup holder assembly 155 is installed and fixed to a seat 100, 200. By pressing in releasing portion 345, a user may apply sufficient force to flex the flex portion from the “initial” position, back to the “insertion position” such that the tab portion 335 is able to freely pass back through and out of the receiving port.

Simply put, tab portion 335 is a protruded portion of engagement member 305 that deflects and flexes towards insertion peg 315 while installing the cup holder assembly 155 to seat 100, 200. The tab portion 335 is configured to hold the cup holder assembly 155 in place and maintain the cup holder assembly in an installed state until the releasing portion 345 is actuated by a user. Specifically, the receiving port (e.g., receiving port 505) is sized and shaped to catch the tab portion 335 once sufficiently flex and advanced into the port.

In an example, portions of engagement member 305, such as flex portion 335, may be made of an elastically deformable material to allow for flexing and/or movement.

For example, engagement member 305 may be made from synthetic resin, polymer, plastic, rubber, or the like. Portions of engagement member 305 may be made of the same or different materials from each other. Additionally, engagement member 305 may be made of the same material or different material than the remaining portions of cup holder assembly 155.

In one example, engagement member 305 is made of a plastic (e.g., polypropylene) and each portion is sized and shaped such that insertion peg 315 is rigid and the flex portion 315 is flexible enough to flex from an “initial” position, towards the insertion peg 315, such that tab portion 335 and releasing portion 345 also flex towards insertion peg 315 until reaching to the “insertion” position.

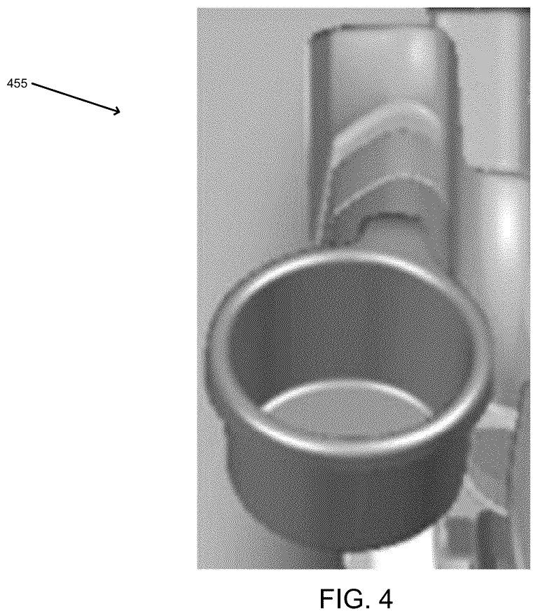

FIG. 4 illustrates an alternative embodiment of a cup holder assembly 455. Cup holder assembly 455 may include one or more feature described herein related to cup holder assembly 155.

FIGS. 5A-5C illustrate examples of receiving port 505. The receiving port 505 may be positioned within the armrest portion 145 of the convertible car seat 100, 200. For example, at a front-end side of the armrest portion 145. As described above, receiving port 505 is sized and shaped and includes corresponding structure to receive engagement member 305 of cup holder assembly 155. Turning now to FIG. 5C, receiving port includes an opening 507 to a cavity 509, the opening and the cavity sized and shaped to house the insertion peg 315, flex portion 325 and tab portion 335 of the engagement member 305. Releasing portion 345 of the engagement member 305 is configured to sit outside of cavity 509 and opening 507. FIG. 5C shows one example of ramp press 515, which is configured to engage tab portion 335 as the ramp-shaped tab is pushed along the ramp press 515. Specifically, the ramp press 515 of the receiving port is configured to contact the ramp-shaped tab portion 335 until the flex portion 325 fully flexes to the “insertion” position and the cup holder assembly 155 can be fully inserted into cavity 509. As illustrated in FIG. 5C, the flex portion 325 is shown in the “initial” position (e.g., flexed back to the “initial” position now that the tab portion 335 and ramp press 515 are no longer in contact and applying forces to each other). After the flex portion 325 flexes back to the “initial” position, the tab portion 335 resides within a tab channel 525 within the cavity 509. Once the tab portion 335 resides within the tab channel 525, the cup holder assembly 155 is fixed to the seat 100, 200 and the ramp press 515 and tab channel 525 are configured to hold the cup holder assembly 155 in position (e.g., fix the cup holder assembly 155 to seat 100, 200) until the releasing portion 345 is actuated by a user.

In many embodiments, the user can release cup holder assembly 155 from the seat 100, 200 in any one of a variety of ways, such as pushing releasing portion 345 towards insertion peg 315 while pulling cup holder assembly 155 outwards and away from seat 100, 200. It should be appreciated that other release mechanisms may be implement such as pushing down the release portion 345, pressing a button on cup holder assembly 155, etc. An additional unlock step may be implemented to prevent a user from unintentionally dislodging or releasing the cup holder assembly 155.

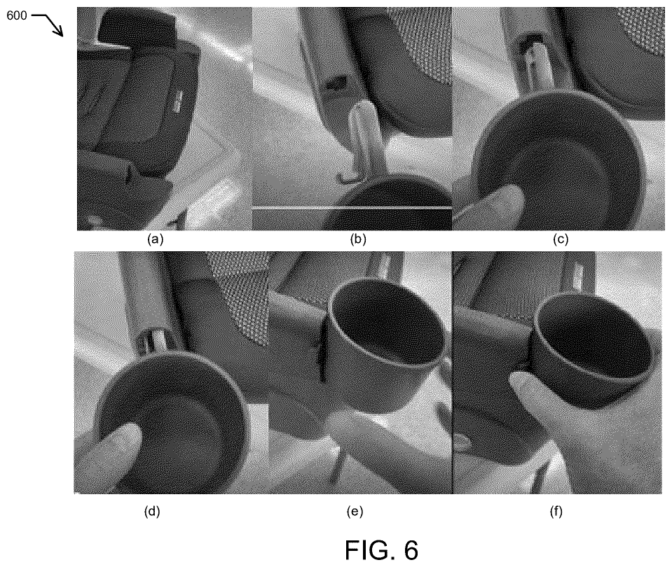

FIG. 6 illustrates a user coupling a cup holder assembly 155 to seat 100, 200 and then pressing in release portion 345 to then uncouple the cup holder assembly 155 to seat 100, 200. As shown in FIG. 6, step (a) shows the seat with receiving port 505 exposed. Step (b) and step (c) illustrate a user bringing a cup holder assembly to the receiving port 505 for installation. As illustrated in step (d), the engagement member is partially received by receiving port 505. In step (d), tab portion 335 is actively engaging with ramp press 515 to flex the engagement member 305 from its “initial” position toward an “insertion” position. In step (e), the cup holder assembly 155 is fully coupled to the seat 100, 200 where the tab portion 335 is housed within channel 525 and the engagement member 305 is housed within cavity 509. At this step, ramp press 515 and channel 525 are configured to hold engagement member 305 (and more specifically tab portion 525) in place, thereby fixing cup holder assembly 155 to seat 100, 200. As illustrated in step (f), a user has actuated the releasing portion to disengage tab portion 335 from ramp press 515 and channel 525 such that the user may uncouple and remove the cup holder assembly 155 from seat 100, 200.

Although the present invention has been described in certain specific aspects, many additional modifications and variations would be apparent to those skilled in the art. In particular, any of the various processes described above can be performed in alternative sequences and/or in parallel in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. It will be evident to the annotator skilled in the art to freely combine several or all of the embodiments discussed here as deemed suitable for a specific application of the invention. Throughout this disclosure, terms like “advantageous”, “exemplary” or “preferred” indicate elements or dimensions which are particularly suitable (but not essential) to the invention or an embodiment thereof, and may be modified wherever deemed suitable by the skilled annotator, except where expressly required. Accordingly, the scope of the invention should be determined not by the embodiments illustrated, but by the appended claims and their equivalents.

1. A convertible car seat comprising:
an outer shell having a seat portion, a back portion and a receiving port;
a base assembly having a mounting mechanism;
a frame; and
a cup holder assembly including an engagement member, the engagement member configured to selectively couple to the outer shell via the receiving port.

2. The convertible car seat of claim 1, wherein the engagement includes an insertion peg connected to a flex portion, a tab portion and a releasing portion.

3. The convertible car seat of claim 2, wherein the tab portion is ramp-shaped.

4. The convertible car seat of claim 2, wherein receiving port includes a ramp press, the ramp press configured to engage the tab portion thereby causing the flex portion to flex towards the insertion peg.

5. The convertible car seat of claim 3, wherein receiving port includes a channel configured to receive and house the tab portion when the cup holder assembly is coupled to the convertible car seat.

6. The convertible car seat of claim 5, wherein the cup holder assembly is removably coupled to the convertible car seat.

7. The convertible car seat of claim 1, wherein the cup holder assembly includes a removable lid.

8. The convertible car seat of claim 1, further comprising a second cup holder assembly.

9. The convertible car seat of claim 1, wherein the convertible car seat is configured to be installed in a vehicle.

10. A cup holder assembly configured to be removably coupled to a car seat, the cup holder assembly comprising:
a receptacle formed by a bottom surface and sidewalls; and
an engagement member, wherein the engagement member includes:
an insertion peg,
a flex portion attached to the insertion peg at a distal end of the engagement member,
a tab portion, and
a releasing portion.

11. The cup holder assembly of claim 10, wherein the tab portion is ramp-shaped.

12. The cup holder assembly of claim 10, wherein the cup holder assembly includes a removable lid.
